(19) United States
(12) Patent Application Publication
(10) Pub. No.: US 2003/0149923 A1
(43) Pub. Date: Aug. 7, 2003

(54) Semiconductor device testing method and test system

(76) Inventor: Mikio Otaki, Tokyo (JP)

Correspondence Address: RABIN & CHAMPAGNE, PC, 1101 14TH STREET, NW, SUITE 500, WASHINGTON, DC, 20005, US

(21) Appl. No.: 10/247,686

(22) Filed: Sep. 20, 2002

(30) Foreign Application Priority Data
Feb. 5, 2002 (JP) 028143/2002

(51) Int. Cl. H04L 1/22

(52) U.S. Cl. 714/724; 714/27

(57) ABSTRACT

According to the present invention, a semiconductor testing method includes the steps of: permitting an ATE processing unit of a reference ATE (Automatic LSI Test Equipment) to accumulate and form summary data of some of the total amount of manufactured semiconductor devices of one lot; permitting the reference ATE to transmit the formed summary data to a host computer through a communication line; permitting the host computer to store the summary data in a recording unit; permitting a determination unit to read the summary data stored in the recording unit; permitting the determination unit to read a quality control reference value; permitting the determination unit to compare and determine the read summary data and the quality control reference value to determine a test item to be edited; permitting an edit unit to edit a test program including the test item to be edited on the basis of the determination by the determination unit; permitting a transmission/reception unit of the host computer to install the edited test program on a plurality of mass production ATEs through the communication line; and permitting the mass production ATEs to execute tests to the other remaining semiconductor devices using the installed test program.

### BACKGROUND OF THE INVENTION

1. Field of the Invention

The present invention relates to a semiconductor device testing method and a test system to implement the method.

2. Description of the Related Art

In recent years, in association with finer division and higher performance realizing of a processing technology for a large scale integrated circuit (LSI), time required for electrical and functional tests performed to manufactured semiconductor devices and investment in test equipment for the devices are increased. The fact exerts an influence upon an increase in manufacturing cost of the semiconductor device. The influence cannot be disregarded.

In association with higher performance realizing of semiconductor devices, necessary test items are further diversified and the number of items is being increased. However, in an actual test processing, for example, when semiconductor devices of tens of lots are processed, executing a test regarding a test item whereby several defectives are detected per million, namely, the defectives are hardly detected causes problems from the viewpoints of time and cost.

For example, Japanese Patent No. 3040233 discloses a semiconductor device testing method. According to this method, when a series of tests serving as a plurality of test items, whereby a plurality of semiconductor device samples to be tested (hereinbelow, each sample is simply referred to as a DUT: Device Under Test) are simultaneously measured, are repetitively executed while samples are changed, the order (sequence) of the test items in the immediately preceding series of tests is changed to the order of a higher defective occurrence ratio at any time and is then executed. In order to implement the testing method, automatic LSI test equipment (hereinbelow, simply referred to as ATE: Automatic Test Equipment) is used.

As mentioned above, according to the method for rearranging the sequence of the test items in descending order of the number of FAILs, a DUT eventually serving as a defective can be found quickly. Accordingly, it is considered that test time and cost can be effectively reduced to some extent.

However, actually in many cases, a test item in which the number of FAILs is large is substantially indicated by test production at a step of mass-producing semiconductor devices. Therefore, merely by rearranging the sequence of the test items, it is difficult to solve a problem of efficiently reducing test items. The problem is the essential problem of reducing the cost in test processing of semiconductor devices.

Test program edit processings such as selection, reduction, and the like of a test item are very difficult. Under present circumstances, all of the processings are executed due to determination and manipulation of a test engineer. Therefore, misreading of summary data or programming errors caused by human errors easily occur. Such a factor causes the following disadvantages. That is, the efficiency of the test processing may be deteriorated and investment in test equipment may be wasted.

Furthermore, there is a disadvantage in that it is difficult to rapidly support a change in a test program corresponding to various kinds of semiconductor devices.

### SUMMARY OF THE INVENTION

According to the present invention, it is an object to provide a semiconductor device testing method in which in a test processing for semiconductor devices, test items can be rapidly optimized in real time during the test processing by editing a test program, the editing including efficient extraction, deletion, and recovery of a substantially unnecessary test item, a processing of editing a sequence of test items is automated to prevent misreading of summary data or a programming error, and the efficiency of the test processing can be improved and excessive investment in test equipment can be suppressed, and to provide a system to implement the method.

According to the present invention, there is provided a semiconductor device testing method comprising the steps of: permitting an ATE processing unit of a reference automatic LSI test equipment (ATE) to accumulate and form summary data of some of the total amount of manufactured semiconductor devices of one lot; permitting the reference ATE to transmit the formed summary data to a host computer through a communication line; permitting the host computer to store the summary data in a recording unit; permitting a determination unit to read out the summary data stored in the recording unit; permitting the determination unit to read out a quality control reference value; permitting the determination unit to compare and determine the read summary data and the quality control reference value to determine a test item to be edited; permitting an edit unit to edit a test program including the test item to be edited on the basis of the determination by the determination unit; permitting a transmission/reception unit of the host computer to install the edited test program on a plurality of mass production ATEs through the communication line; and permitting the mass production ATEs to execute tests to the other remaining semiconductor devices using the installed test program.

According to this method, in a test processing for semiconductor devices, test items can be optimized rapidly in real time during the test processing by editing a test program, the editing including efficient extraction, deletion, and recovery of a substantially unnecessary test item. The ATEs simultaneously execute processings of editing a sequence of test items. The processings are automated. Consequently, misreading of summary data and programming errors can be prevented, the efficiency of the test processing can be improved, and excessive investment in test equipment can be suppressed.

In this specification, “deleting” a test item or a program does not always mean deletion thereof. In other words, for example, a program exists but the program is not executed by any processing (such as mask processing or the like). In this instance, although the program exists in a sequence, the program subjected to the mask processing is skipped and a program arranged next to the skipped program is executed. In order to recover the program subjected to, for example, the mask processing so that the program can be executed, the mask processing may be released.

According to the present invention, there is provided a semiconductor device test system comprising a host computer and a plurality of ATEs connected to the host computer, wherein the host computer comprises a recording unit to record data and a program, a determination unit which compares and determines the data, an edit unit which edits the program, and a transmission/reception unit which transmits or receives the data and the program, the ATEs are at least one reference ATE comprising an ATE processing unit, which counts the number of FAILs of semiconductor devices of each lot every test item and forms summary data obtained by compiling the numbers, and a plurality of mass production ATEs other than the reference ATE, and the host computer is connected to each of the ATEs through a communication line so that the host computer can transmit or receive the data and the program to/from each ATE.

According to the test system of the present invention, deleting or recovering a test item, namely, a test program edit processing can be rapidly, easily, and automatically executed simultaneously in the ATEs. Consequently, the test processing of the present invention can be efficiently executed.

### BRIEF DESCRIPTION OF THE DRAWINGS

FIG. 1 is a diagram for schematically explaining a configuration of a semiconductor device test system according to the present invention;

FIG. 2 is a flowchart for explaining editing steps of a test program, namely, the operation of selecting, deleting, and/or recovering a test item;

FIG. 3 is a diagram for explaining an edit processing of full test items for a reference ATE 30a;

FIG. 4 is a block diagram showing the processing operation of deleting test items; and

FIG. 5 is a block diagram showing the processing operation of recovering test items.

### DESCRIPTION OF THE PREFERRED EMBODIMENT

An embodiment of the present invention will now be described hereinbelow with reference to the drawings. In the drawings, numerical conditions, the size and shape of each component, and the layout are merely schematically illustrated as an example in order to understand the present invention. The present invention is not limited to the example. In the following description, the same components in the drawings are designated by the same reference numerals and their overlapped description may be omitted.

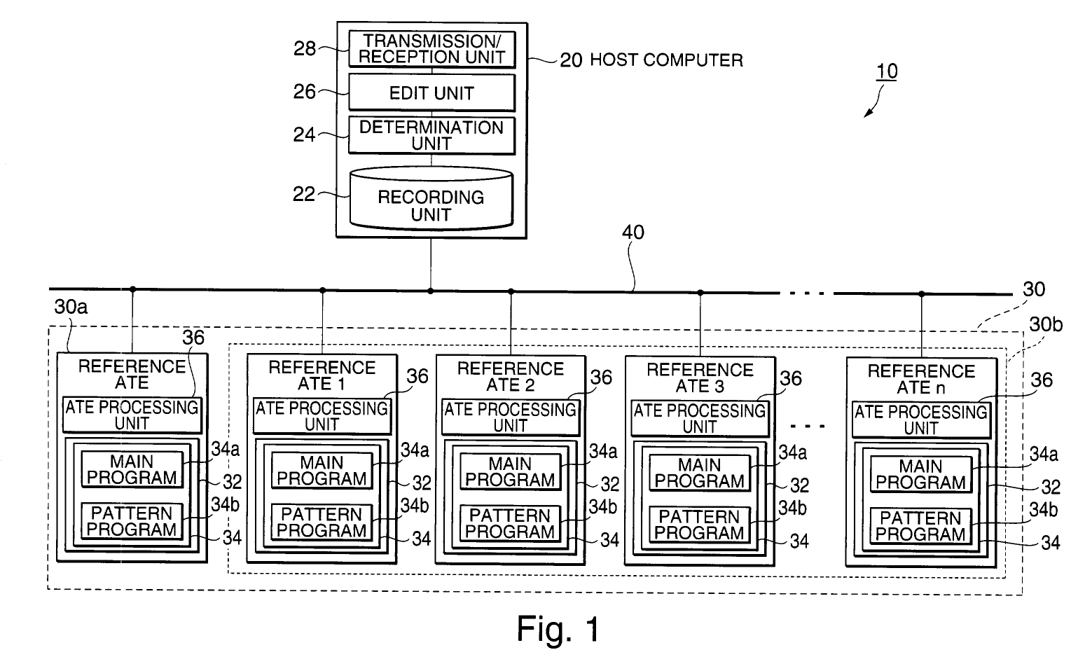

First, a configuration of a semiconductor device test system according to the present invention will now be described with reference to FIG. 1. FIG. 1 is a diagram schematically showing a configuration of a semiconductor device test system 10 of the present invention.

The semiconductor device test system 10 comprises a host computer 20, an ATE group 30, and a communication line 40 to connect the host computer 20 to the ATE group 30.

The host computer 20 comprises a recording unit 22, a determination unit 24, an edit unit 26, and a transmission/reception unit 28. The recording unit 22 comprises a mass storage medium. The recording unit 22 can be built in the host computer 20 or can be connected to the outside thereof. For example, the recording unit 22 comprises a magnetic disk unit, specifically, a hard disk drive. The recording unit 22 functions to store various data and programs.

The determination unit 24 is a functional part which can read data and determine these data.

The edit unit 26 is a functional part which can edit software such as a program on the basis of a result of the processing by the determination unit 24.

The transmission/reception unit 28 is a functional part which can transmit or receive data or a program to/from another device connected to the outside. The above units can function in connection with each other.

In the above description, the detailed description regarding a specific hardware configuration of each of the other components other than the recording unit 22 is omitted because it is not the substance of the present invention. The host computer 20 has at least the components corresponding to the determination unit 24, the edit unit 26, and the transmission/reception unit 28 in terms of functions.

The ATE group 30 includes at least one reference ATE 30a and a plurality of ATEs, namely, a mass production ATE group 30b having a mass production ATE 1, a mass production ATE 2, a mass production ATE 3, . . . , and a mass production ATE n.

Preferably, the reference ATE 30a and each mass production ATE constituting the mass production ATE group 30b have the same configuration.

An ATE recording unit 32 stores a test program 34 including a main program 34a and a pattern program 34b.

The main program 34a is program software in which a pattern program, namely, an execution sequence of function tests and programs of DC tests (meaning electrical direct-current tests for the DUT) have been recorded. The program software controls the setting of a test circuit, the starting of the DC test and the pattern program, measurement, data acquisition, and comparison and analysis of data.

The pattern program 34b is program software which executes function tests of a plurality of items. The pattern program 34b may be modularized every item of the function test.

A test processing for semiconductor devices will be described from the viewpoint of the relationship between the main program 34a and the pattern program 34b. The pattern program 34b (module) executes the function tests. The main program 34a does not directly execute the tests. The execution order (sequence) of the test items of a plurality of function tests has been recorded in the main program 34a. In other words, the main program 34a starts the pattern program (module) in accordance with the arrangement of the test items of the determined function tests, and permits the pattern program to execute a function test of a specified test item.

An ATE processing unit 36 controls communication with the transmission/reception unit 28 of the host computer 20 through the communication line 40, FAIL test counting, namely, counting the number of FAILs in each test item, and formation of summary data obtained by accumulating and arranging the number of counted FAILs every lot and every test item.

A specific configuration of each ATE serving as the reference ATE 30a or each ATE constituting the mass production ATE group 30b will not be explained in detail because it is not the substance of the present invention. In addition to a general semiconductor device testing function of the ATE, the ATE has at least components corresponding to the ATE recording unit 32 storing the main program 34a and the pattern program 34b, and the ATE processing unit 36 in terms of functions.

Each ATE constituting the ATE group 30 is connected to the transmission/reception unit 28 of the host computer 20 so that data communication can be accomplished therebetween.

Regarding the communication line 40 in this case, a cable can be used or wireless communication can also be used. In other words, data communication can be accomplished using a medium such as electricity, light, or a radio wave. Specifically, for example, Ethernet may be used. For connection topology, FIG. 1 shows a bus topology. The topology is not limited to this case. For example, a star topology can be used.

A testing method by the semiconductor device test system 10 according to the present invention will now be described hereinbelow with reference to the drawings.

1. Setting of Quality Control Reference Value

As a precondition before the start of testing, a quality control reference value is initially set. In this case, the quality control reference value means the number of FAILs which is allowable in each test item, the number of FAILs being calculated on the basis of the percentage of mixture of defective that is finally allowable in one lot (or a predetermined amount of one lot) of produced semiconductor devices. The quality control reference value is independently set as a reference value for each test item. The quality control reference value is set prior to the execution of tests and is then stored in the recording unit 22 of the host computer 20.

2. Summary Data Accumulation

Summary data accumulation by the reference ATE 30a will now be described.

Generally, a wafer-level lot and a package-level lot exist serving as manufacturing lots of semiconductor devices. The testing method and the test system according to the present invention are suitably applied to any lot. For example, in case of the wafer-level lot, generally, the number of wafers of one lot is equal to 20 to 50. In case of the package-level lot, generally, the number of packages of one lot is equal to 1000 to 200000.

The reference ATE 30a performs full tests to DUTs whose number is set appropriately in consideration of the kind of a wafer-level or package-level semiconductor device, its quality control reference, and turnaround time. Preferably, DUTs of about 10% of the total number of devices of one lot are sampled at random.

Serving as test items performed in this instance, all of the test items, namely, full test items necessary for a specific kind of semiconductor device are used.

The reference ATE 30a tests the randomly sampled DUTs of about 10% of one lot. The ATE processing unit 36 counts the number of FAILs of each test item in the full tests. Thus, summary data is formed. The summary data is transmitted through the communication line 40 and is then received by the transmission/reception unit 28 of the host computer 20. After that, the data is stored in the recording unit 22.

3. Editing and Determining Steps of Test Program

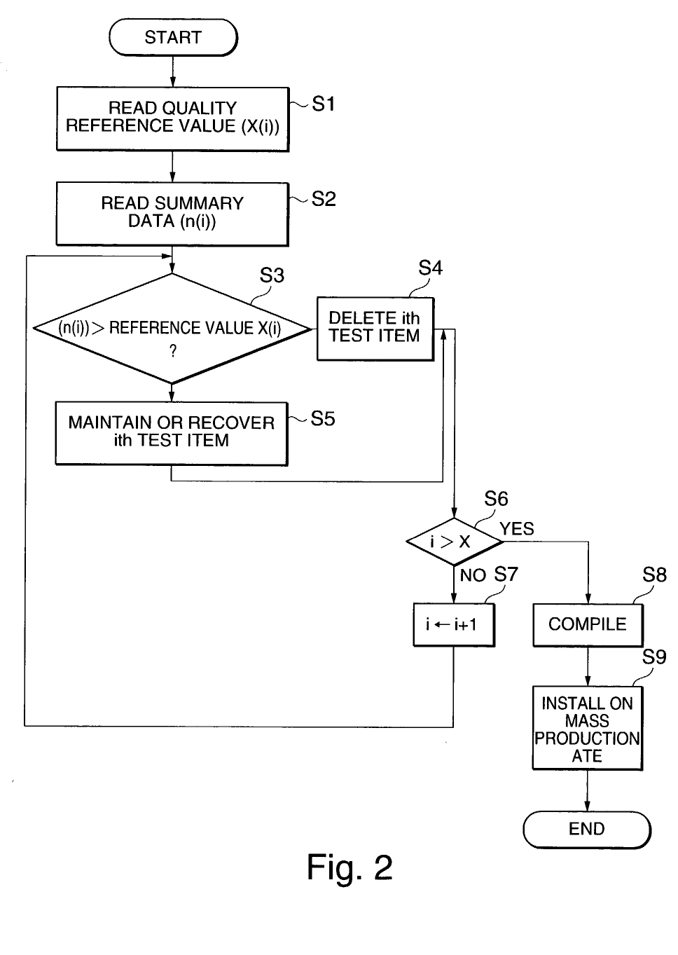

FIG. 2 is a flowchart for explaining editing steps of the main program performed by the determination unit 24 of the host computer 20, specifically, steps of determining maintenance, deletion, and/or recovery of a test item in the main program including the test items and then executing the operation. In the following description, a processing step is shown by reference symbol S.

In this case, the description will be made on the assumption that X test items exist serving as DC tests to be executed and X test items exist serving as function tests to be executed. In this instance, it is assumed that the value of summary data corresponding to the ith test item is shown by n(i) and a quality control reference value corresponding to the ith test item is shown by X(i).

The main program 34a is edited in the host computer 20. At the start of editing, the determination unit 24 of the host computer 20 reads a quality control reference value stored in the recording unit 22 (S1). Subsequently, the determination unit 24 of the host computer 20 reads summary data similarly stored in the recording unit 22 (S2).

The step of reading the quality control reference value and the step of reading the summary data can be performed in the reverse order.

Subsequently, the read summary data is compared with the read quality control reference value, the summary data and the reference value being related to the same item. That is, whether summary data n(i) corresponding to the test item is equivalent to or larger than the corresponding quality control reference value X(i) is determined (S3). If NO, namely, if the summary data n(i) is equivalent to the reference value X(i) or smaller, the corresponding test item is deleted (S4). On the other hand, if YES, namely, if the summary data n(i) is larger than the reference value X(i), the corresponding test item is maintained during the steps. If the test item has already been deleted, the test item is recovered (S5).

As mentioned above, steps S3 to S5 are sequentially performed in all of the X test items. In other words, when step S4 or S5 is finished, whether i is larger than X is determined (S6). If NO, namely, if i is smaller than X, i is set to (i+1) (S7) and the processing is returned to step S3. Steps S3 to S5 are repeated in a loop manner until i is equivalent to X. If YES, namely, if i is equivalent to X, it is determined that all of the test items have been determined and edited.

Subsequently, the edit unit 26 compiles the edited main program 34a to validate the program (S8). The compiled main program 34a is transmitted to each ATE of the mass production ATE group 30b, if necessary, is also transmitted to the reference ATE 30a by the transmission/reception unit 28 of the host computer 20 through the communication line 40. The transmitted program is installed on the ATE recording unit 32 of each ATE (S9). The series of steps completes the editing of the test program of the mass production ATE group 30b.

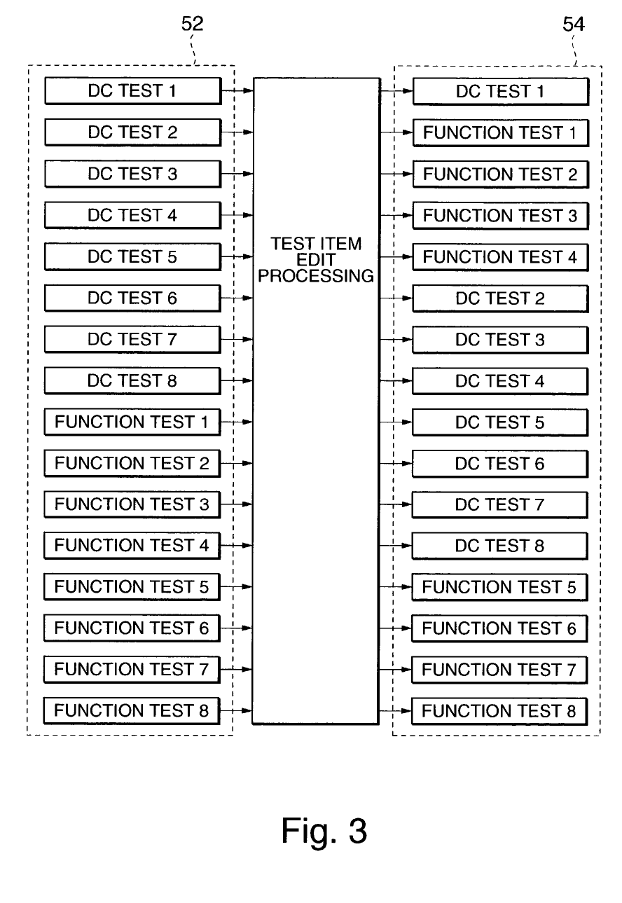

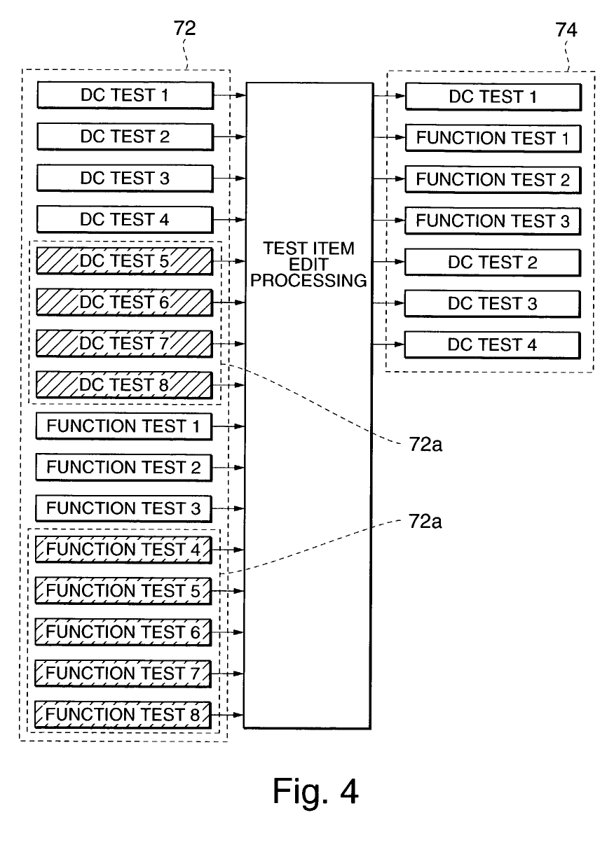

The operation of editing the test items will now be described more specifically with reference to FIGS. 3 and 4 and Tables 1 and 2. It is assumed that each DUT has a form serving as a specific kind of package and the number of devices of one lot is set to, e.g., 10000. 10% of the total number of devices of one lot, namely, 1000 devices are sampled at random and are then tested by the reference ATE 30a. Thus, summary data is accumulated. Each quality control reference value, namely, each set value of the number of FAILs that is allowable in each test item is set to “2”. The value has been stored in the recording unit 22 of the host computer 20.

1. Processing of Editing Full Test Items

FIG. 3 is a diagram for explaining a processing of editing the full test items for the reference ATE 30a.

The determination unit 24 of the host computer 20 performs the edit processing. First, a program table 52 serving as a table of test items of the DC tests and the function tests necessary for each DUT to be tested is formed. The formed table is stored in the recording unit 22. Subsequently, in order to efficiently execute the full tests, the items of the DC tests and the function tests are rearranged. For example, when a test item, which will be easily failed, is known on the basis of test production, this test item is advanced. Alternatively, the order of, e.g., a basic DC test is advanced irrespective of the number of FAILs. As mentioned above, a reference ATE program sequence 54 optimized in the relation between the DC tests and the function tests directly executed by the main program 34a is determined. The edit unit 26 performs a processing of editing the entire main program 34a including the reference ATE program sequence 54. The edited main program 34a is stored in the recording unit 22. For the main program 34a to be edited in this case, the main program existing in the ATE recording unit 32 of the reference ATE 30a may be stored in the recording unit 22 of the host computer 20 through the communication line 40 and be then edited. Alternatively, the main program stored in the recording unit 22 can be edited.

The main program 34a including the reference ATE program sequence 54 subjected to the edit processing is read from the recording unit 22 and is then complied by the edit unit 26. After that, the complied main program 34a is transmitted to the reference ATE 30a through the communication line 40. The transmitted main program is installed (overwritten) on the ATE recording unit 32 of the reference ATE 30a which receives the main program. By the above operation, the processing of automatically editing the test items of the reference ATE 30a is completed. The reference ATE 30a can execute the full test items determined as necessary items.

2. Summary Data

Table 1 illustrates an example (1) of summary data accumulated and formed by the reference ATE 30a and shows summary data of the present lot and summary data of the three preceding lots. The data is summarized every DC test group and every function test group. Therefore, the test items are arranged different from the actually executed reference ATE program sequence 54 shown in FIG. 3. A box 62 includes the test items, in each of which the number of FAILs is equivalent to or smaller than the quality control reference value corresponding to the test item, namely, the number of FAILs is equal to “2” or less, in the DC tests 1 to 8. A box 64 includes the test items, in each of which the number of FAILs is equivalent to or smaller than the quality control reference value corresponding to the test item, namely, the number of FAILs is equal to “2” or less, in the function tests 1 to 8. Accordingly, it is determined that the DC tests 5 to 8 and the function tests 4 to 8 can be omitted (steps S3 and S4 in FIG. 2) in the tests for each lot performed by the mass production ATE.

Table 2 illustrates an example (2) of summary data accumulated and formed by the reference ATE 30a. Each of boxes 66 and 68 denotes a test item which can be omitted in the preceding lots but, in the present lot, the number of FAILs serving as a result in the full tests (all of the test items determined to be needed) by the reference ATE 30a is larger than the set quality control reference value, namely, “2”. Consequently, it is determined that the test items should be recovered (steps S3 and S5 in FIG. 2) in the tests by the mass production ATE group 30b. Accordingly, in the tests for the lot performed by the mass production ATE group 30b, the programs corresponding to the DC test 5 and the function test 4 are recovered and are then executed by the host computer 20 as mentioned above.

3. Detailed Description of Deleting Operation

A test item edit processing of deleting a test item will now be described hereinbelow principally with reference to FIG. 4.

FIG. 4 is a block diagram for explaining the operation of deleting a test item. In a program table 72, programs 72a to be deleted, the programs being hatched, namely, the DC tests 5 to 8 and the function tests 4 to 8 are extracted from the results (corresponding to the boxes 62 and 64 in Table 1) of the full tests by the reference ATE 30a. The determination unit 24 of the host computer 20 determines that it is unnecessary to execute these test items (steps S3 and S4 in FIG. 2) in the tests for the present lot performed by the mass production ATE group 30b. A mass production ATE program sequence 74 is a program sequence whereby the mass production ATE group 30b executes the tests.

The edit processing is executed by the determination unit 24 and the edit unit 26 of the host computer 20. As mentioned above, the host computer 20 initially reads out a quality control reference value (S1 in FIG. 2). Subsequently, the host computer 20 reads out summary data accumulated by the reference ATE 30a (in this case, summary data in Table 1) (S2 in FIG. 2). The determination unit 24 of the host computer 20 compares and determines the quality control reference value and the value of the summary data, each of which corresponds to each test item of the program table 72 (S3 in FIG. 2). In this instance, it is assumed that the compared summary data relates only to the present lot. A mean value of each test item, the value obtained using the results of the preceding lots, can also be used. The determination unit 24 determines that each of the values of the summary data in the boxes 62 and 64 in Table 1 is not larger than the corresponding quality control reference value (NO in S3). The edit unit 26 extracts the test items corresponding to the boxes 62 and 64 of the main program 34a and then performs the test item edit processing of deleting the test items (S4 in FIG. 2).

At that time, in order to efficiently perform the tests by the mass production ATE group 30b, the determination unit 24 arranges the test items on the basis of the read-out summary data in a high order of possibility that the device is determined as a defective. Namely, the determination unit 24 advances an item in which a defective may be found easily, determines the mass production ATE program sequence 74 in which the arrangement is optimized, and then stores the program sequence 74 in the recording unit 22. Subsequently, the edit unit 26 reads out the determined mass production ATE program sequence 74 from the recording unit 22 and then performs the test item edit processing. The edit unit 26 compiles the main program 34a (S8 in FIG. 2). After that, the main program 34a is transmitted from the transmission/reception unit 28 of the host computer 20 to the mass production ATE group 30b through the communication line 40. The transmitted main program 34a is simultaneously installed (overwritten) in parallel on the respective ATE recording units 32 of the ATEs constituting the mass production ATE group 30b (FIG. 1 and S9 in FIG. 2). Thus, the automatic processing of simultaneously editing the test items in parallel in the ATEs constituting the mass production ATE group 30b is completed. The tests by the ATEs constituting the mass production ATE group 30b can be efficiently executed using the minimum test items of the optimized sequence.

After that, except for DUTs subjected to the full tests by the reference ATE 30a, remaining 90% of DUTs are subjected to the tests. Steps of the tests are executed in parallel by the mass production ATE group 30b comprising the ATEs. The full tests with accumulating summary data performed by the reference ATE 30a and the tests by the mass production ATE group 30b are repetitively executed to each lot.

4. Detailed Description of Recovery Operation

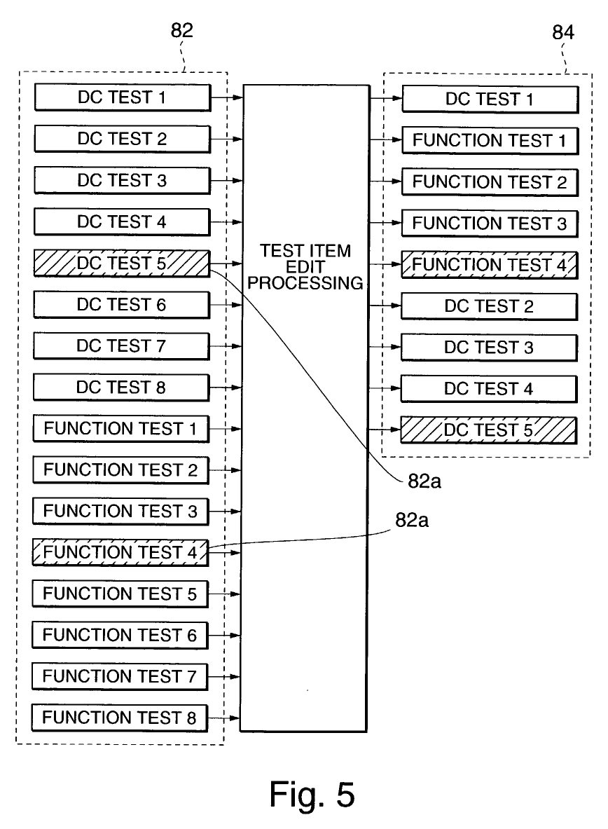

Subsequently, the test item edit processing of recovering the test item, which was deleted once, will be described principally with reference to FIG. 5. In this case, it is assumed that the DC tests 5 to 8 and the function tests 4 to 8 do not exist in a mass production ATE program sequence 84 due to the above-mentioned deleting operation.

FIG. 5 is a block diagram for explaining the test item recovery operation. In a program table 82, recovery target programs 82a, which are hatched, namely, the DC test 5 and the function test 4 are determined as recovery target programs in the tests for the present lot performed by the mass production ATE group 30b on the basis of the results (corresponding to the boxes 66 and 68 in Table 2) obtained by the full tests by the reference ATE 30a. The mass production ATE program sequence 84 is a sequence of test programs included in the main program 34a which is actually installed on the mass production ATE group 30b.

The edit processing is also executed by the determination unit 24 and the edit unit 26 of the host computer 20. As mentioned above, the determination unit 24 first reads out a quality control reference value (S1 in FIG. 2) and then reads out summary data (in this case, summary data in Table 2) accumulated by the reference ATE 30a (S2 in FIG. 2). The determination unit 24 compares and determines the value of each summary data and the corresponding quality control reference value, each of which corresponds to each test item of the program table 82 (S3 in FIG. 2). At this time, it is assumed that summary data to be compared similar to the above description relates only to the present lot.

Subsequently, the determination unit 24 determines that each of the values of the summary data shown in the boxes 66 and 68 in Table 2 is larger than the quality control reference values. On the basis of the recovery determination by the determination unit 24, the edit unit 26 executes the test item edit processing of recovering the recovery target programs 82a, namely, the DC test 5 and the function test 4 (S5 in FIG. 2).

Further, if necessary, the determination unit 24 rearranges the items of the DC tests and the function tests in order to efficiently execute the tests in a manner similar to the above description. Thus, by rearranging in addition to editing such as deleting and recovering the test item, the mass production ATE program sequence 84 is determined so that the sequence is optimized especially from the viewpoint of the relationship between the DC tests and the function tests, which the main program 34a directly executes. The determination unit 24 executes the test item edit processing on the basis of the determined program sequence 84. The edit unit 26 compiles the main program 34a subjected to the edit processing and then stores the program 34a in the recording unit 22 (S8 in FIG. 2). After that, the main program 34a is read from the recording unit 22 and is then transmitted from the transmission/reception unit 28 to the mass production ATE group 30b through the communication line 40. The transmitted main program 34a is installed (overwritten) on the ATE recording unit 32 of each of the ATEs constituting the mass production ATE group 30b. By the above-mentioned operation, the automatic processing of simultaneously editing the test items in parallel in the ATEs constituting the mass production ATE group 30b is completed. The tests by the ATEs comprising the mass production ATE group 30b can be executed using the minimum test items of the optimum sequence.

After that, except for DUTs which have been subjected to the full tests by the reference ATE 30a, remaining 90% of DUTs are subjected to the tests. The testing steps are executed in parallel by the mass production ATE group 30b including the ATEs. The full tests with accumulating summary data performed by the reference ATE 30a and the tests using the minimum and optimum test items by the mass production ATE group 30b are repetitively performed to each lot of semiconductor devices.

As understood from the above explanation, according to the configuration of the semiconductor device test system of the present invention, a test item that is not required substantially can be efficiently determined in a test processing for semiconductor device. Deleting or recovering a test item, namely, editing a test program can be automatically performed in real time in parallel in the ATEs. Consequently, the test processing can be efficiently executed. Therefore, the cost of the test processing and the cost of investment in equipment for the test processing can be reduced. The invention contributes to reduced total cost in manufacturing the semiconductor device.

What is claimed is:

1. A semiconductor device testing method comprising the steps of:
permitting an ATE processing unit of a reference ATE (Automatic LSI Test Equipment) to accumulate and form summary data of some of the total amount of manufactured semiconductor devices of one lot
permitting the reference ATE to transmit the formed summary data to a host computer through a communication line;
permitting the host computer to store the summary data in a recording unit;
permitting a determination unit to read out the summary data stored in the recording unit;
permitting the determination unit to read out a quality control reference value;
permitting the determination unit to compare and determine the read summary data and the quality control reference value to determine a test item to be edited;
permitting an edit unit to edit a test program including the test item to be edited on the basis of the determination by the determination unit;
permitting a transmission/reception unit of the host computer to install the edited test program on a plurality of mass production ATEs through the communication line; and
permitting the mass production ATEs to execute tests to the other remaining semiconductor devices using the installed test program.

2. The method according to claim 1, wherein
in the step of permitting the determination unit to compare and determine the read summary data and the quality control reference value to determine a test item to be edited, when the value of the summary data of a specific lot and a specific test item is larger than the quality control reference value, the specific test item is maintained or recovered as a test item to be edited, and when the value of the summary data is equivalent to the quality control reference value or less, the specific test item is deleted as a test item to be edited.

3. A semiconductor device test system comprising a host computer and a plurality of ATEs connected to the host computer, wherein
the host computer comprises a recording unit to record data and a program, a determination unit which compares and determines the data, an edit unit which edits the program, and a transmission/reception unit which transmits or receives the data and the program,
the ATEs are at least one reference ATE comprising an ATE processing unit, which counts the number of FAILs of semiconductor devices of each lot every test item and forms summary data obtained by compiling the number, and a plurality of mass production ATEs other than the reference ATE, and
the host computer is connected to each of the ATEs through a communication line in order to transmit or receive the data and the program thereto or therefrom.

4. The system according to claim 3, wherein
the ATE comprises an ATE recording unit having a main program and a pattern program, and the ATE processing unit.

5. The system according to claim 4, wherein
the main program comprises an execution sequence of function tests and a program of DC tests and functions as a program to control the setting of a test circuit, the starting of the DC test and the pattern program, measurement, data acquisition, data comparison and analysis.

6. The system according to claim 4, wherein
the pattern program is a program to execute function tests of a plurality of items.
